(19) United States
(12) Patent Application Publication
(10) Pub. No.: US 2026/0024689 A1
(43) Pub. Date: Jan. 22, 2026

(54) SUPERCONDUCTING COMPACT ENERGY CELL (CEC)

(71) Applicant: NDI Engineering Company, Thorofare, NJ (US)

(72) Inventors: William M. Adams, Thorofare, NJ (US); Michael J. Mielnik, Palmyra, VA (US); Owen R. Christianson, Reston, VA (US); David H. Korn, Thorofare, NJ (US); Charlie B. Baume, Thorofare, NJ (US); John V. Corcoran, III, Thorofare, NJ (US)

(73) Assignee: NDI Engineering Company, Thorofare, NJ (US)

(21) Appl. No.: 19/271,369

(22) Filed: Jul. 16, 2025

Related U.S. Application Data
(60) Provisional application No. 63/672,014, filed on Jul. 16, 2024.

(51) Int. Cl. H01F 6/06; H01F 6/04; H01F 27/02

(52) U.S. Cl. CPC H01F 6/06; H01F 6/04; H01F 27/02

(57) ABSTRACT

A compact superconducting energy storage cell includes a CEC Coil Assembly comprised of a plurality of axially stacked CEC Coil Modules. Each CEC Coil Module has two, double-pancake HTS coils and at least one coil assembly circumferentially surrounding the coil core. The coil assembly has at least two coils of superconductor coil windings with at least one spacer disposed therebetween with the at least two coils and the at least one spacer being stacked along the central axis. An insulator sleeve is disposed about the CEC Coil Assembly. A radiation shield cup and a radiation shield cap together define a first interior containing the insulator sleeve encapsulating the four axially stacked CEC Coil Modules. An outermost enclosure having an outermost chamber and an outermost cap together define a second interior that contain the at least one inductor module disposed therein.

### CROSS REFERENCE TO RELATED APPLICATIONS

This application claims priority from U.S. Provisional Application Ser. No. 63/672,014, titled SUPERCONDUCTING COMPACT ENERGY STORAGE CELL (CEC), filed Jul. 16, 2024, and incorporated herein in its entirety by reference.

### FIELD OF THE INVENTION

The subject matter disclosed herein relates to high energy density superconducting inductor assemblies.

### BACKGROUND OF THE INVENTION

An inductor is a coil of electrically conductive material that stores energy in a magnetic field. As the current through the inductor increases, the amount of energy stored in the magnetic field decreases based on the electrical resistance of the inductor material (thermal losses or Joule heating). To maximize energy stored in a magnetic field, inductors utilize superconductive material, or a material which exhibits zero electrical resistance in specific environmental conditions. Creating and maintaining the environmental conditions for high temperature superconductors (30-90 K) to achieve superconductivity is complex, expensive, and not reasonably scalable for most desired applications, including but not limited to, wind turbines, large scale solar battery storage systems, magnetic lift applications, imaging equipment, grid power quality and high energy pulsed lasers.

Superconducting Magnetic Energy Storage (SMES) systems store energy in a magnetic field. Conventionally, a coil of conducting cable, with a round or rectangular cross section is wound into various shaped coils. The coils can be linear or wound in layers and can include a ferrite core or an air core. SMES coils typically have an air core to avoid saturating the magnetic field, which can occur with high magnetic fluxes. A magnetic field is created by the flow of current in a conductor. This magnetic field is amplified when the conductor is configured as a coil. The wound coil must be operated below its superconducting critical temperature, critical current and magnetic flux density to avoid thermal losses from Joule heating. These three parameters are referred to as the critical surface. The closer the modules are coupled, the more efficient the electrical and thermal management. In the same manner, the close coupling enables the individual cell magnetic fields to inductively couple, and amplify their mutual inductance, thereby providing the environment for greater energy density storage.

A SMES inductor is an application specific circuit with a current flow creating a magnetic field in the coil, storing energy. Once the coil is charged, the current source can be removed and the energy remains stored in the coil's magnetic field until discharged. The coil is cooled by a working fluid and a refrigerant system and uses superconducting metals. The more efficient the SMES design packaging is the less coolant is required, thereby resulting in lower operation costs and higher efficiencies.

The field of Superconducting Magnetic Energy Storage (SMES) is of commercial interest because SMES technology permits very large amounts of energy to be stored indefinitely and dissipated back into a network with theoretically no loss, depending on the application need. Small scale systems under a kilojoule are cost prohibitive due to the large overhead associated with the vacuum and cryogenic systems necessary to maintain the superconducting environment for the storage coils. Large scale systems have significant market potential for very high energy storage but the relative size to support a large-scale renewable energy farm is multiple kilometers in diameter.

Thus, a small-scale modular design that provides improvements in terms of safety, manufacturability, and is linearly scalable in energy storage without expanding the cost, is desired. Second generation of Type II superconductors that operate at significantly higher Critical Current (Ic) and Critical Temperatures (Tc) can be used to create modular and scalable assemblies of Compact Energy Cells (CECs). CEC devices allow for simple fabrication, and can be assembled in any desired size and configuration to suit a particular application and desired energy requirements. Commercial Utility requirements for power generation support and electrical distribution fall in this category to varying degrees. Some examples for those types of applications are: a) Compact energy storage for load leveling and load following with near instantaneous response, b) Power Quality improvement, including reduction of harmonic distortion and sub-synchronous resonance damping; c) Reactive volt-ampere (VAR) control and power factor correction; d) Cold Start Capability when no alternate source is available; e) Transient voltage drop mitigation; f) Wind Turbine Generator Stability during system disturbances and g) Minimization of Wind Turbine Generator power and voltage fluctuations.

### SUMMARY OF THE INVENTION

According to an embodiment of the invention, a solid-state inductor module, referred to herein as the Compact Energy Cell (CEC), is provided. The Compact Energy Cell (CEC) is a CEC Coil Assembly 1000 consisting of at least one CEC Coil Module (CCM) 100 secured in a CEC “Cold-Can” enclosure 400 using Helium as the cooling medium. Each CCM 100 comprises two Double-Pancake HTS Coils 160 where each Double-Pancake HTS Coil 103 is suspended between a CCM Spacer 130 (FIG. 10A-10B). The CCM Spacers 130 act as a structural support to stabilize the Double-Pancake HTS Coils 160 and prevent damage from the strong magnetic fields and subsequent Lorentz forces. The CCM Spacers 130 also act as a conduit for Helium gas to cool the Double-Pancake HTS Coils 160 within the CCM 100. The CCM Spacers 130 are constructed using an anti-magnetic stiffener made from G10 (high-pressure fiberglass laminate) embedded in low outgassing (Total Mass Loss—TML of less than 1%, more preferably less than 0.5%, and in embodiments less than 0.2%, e.g. 0.17%), extreme low temperature liquid silicone rubber (LSR) that acts as cold plate when the LSR reaches the glass state (Tg). As used herein, the term “extreme low temperature” LSR refers to LSR suitable for cryogenic service and having a service temperature range/low temperature flexibility extending below −90° C., preferably to −110° C. or lower). By “low outgassing,” one skilled in the art would understand from the description herein that “outgassing” refers to performing an assessment to measure how much of a material is lost (e.g., water, gas, etc.) when a system is subjected to a vacuum. The test is typically conducted over a 24-hour period. NASA defines low outgassing materials as those with a TML less than 1.00% and a Collected Volatile Condensable Material (CVCM) value of less than 0.10%. Examples of “extreme low temperature” LSR used to construct one or more components of the CEC, including the CCM spacers 130, include but are not limited to: (1) Dow Chemical DOWSIL™ 93-500 Liquid Silicone Rubber (having a specified service temperature range lower bound of −115° C.); (2) SSP-SSP2575 Liquid Silicone Rubber (having a specified low temperature flexibility at −116° C. (−177° F.)); and (3) Apple Rubber AMS 3336, AMS 3337, AMS 3338 Liquid Silicone Rubber (having a specified service temperature range lower bound of −121° C.).

The CCM Core 120 (FIG. 9) is constructed by embedding a non-magnetic stiffener in the same LSR material used to construct the CCM Spacers 130. To transfer the cooling medium, Helium, to the bottom of the CCM 100, the Helium Gas Inlet 412 is press fit into the through the inside diameter of the CCM Core 120. Additionally, the CCM Core 120 has a channel defining a central axis running the length of the CCM Core 120 to accept the “sunken key” (FIG. 8) that is integrated into the anti-magnetic stiffener of the CCM Spacer 130. In a CCM, a total of five CCM Spacers 130 are slid onto the CCM Core 120 and secured into place using a CCM Nut 110. The CCM Nut 110 is constructed using the same anti-magnetic material as the stiffeners of the CCM Core 120 and CCM Spacer 130. The channel of the CCM Core prevents rotational while the CCM Nut 110 prevents lateral movement of the CCM Spacers 130 and subsequently the Double-Pancake HTS Coils 160.

To contain the helium within a CEC Coil Assembly 1000, the CCM 100 utilizes CCM Plenum Shell 170, a Top Plenum Nut 210, a Top Plenum Cap 220, a Bottom Plenum Cap 240 and Middle Plenum(s) 230 if CCMs are stacked vertically. The CCM Plenum Shell 170, Top Plenum Cap 220, Top Plenum Nut 210, Bottom Plenum Cap 240 and Middle Plenum 230 are constructed using the same anti-magnetic material as the stiffeners of the CCM Core 120 and CCM Spacer 130. The Plenum Pin 150 variations (FIG. 12) and Top Plenum Cap 220 are press fit into the oval slots in the CCM Spacer 130 and head of CCM Core 120 respectively. The Top Plenum Nut 210 screws into the head of the CCM Core 120 and similarly the Bottom Plenum Cap 240 screws onto the bottom the CCM Core 120. There is only one Top Plenum Cap 220 and one Bottom Plenum Cap 240 when stacking CCMs 100 vertically. Between each CCM 100 there is a Middle Plenum 230 that press fits onto the head of the CCM Core 120. The head and bottom of the CCM Core 120 have mating threads; allowing CCMs 100 to be threaded directly together. The Bottom Plenum Cap 240 forces incoming Helium from the inside diameter of the CCM Core 120 to flow into the bottom CCM Spacer 130. As the LSR material is porous at cryogenic temperatures, Helium continues to rise to the Double-Pancake HTS Coils 160. Using combination of five Plenum Pins 171, 173, 174, and 175 to create a shell to enclose the Double-Pancake HTS Coils 160 and CCM Spacers 130 thus forcing the Helium through the Double-Pancake HTS Coils 160. Once through the top CCM Spacer 130, the Helium flows through the Top Plenum Cap 220. The Top Plenum blocks the Helium from flowing back down the exterior of the CCM 100 and thereby existing the CEC “Cold-Can” enclosure 400 through the Helium Gas Exhaust Outlet 414.

A complete CEC Coil Assembly 1000 contains at least one CCM 100, a Top Plenum Cap 220, a Top Plenum Nut 210, a Bottom Plenum Cap 240, and if CCMs 100 are stacked axially Middle Plenum(s) 230. In radially stacked or ‘cluster’ CCMs 100, the Top Plenum Cap 220 has the same number of press fit holes as the number of CCM column(s) where each CCM 100 column has a Bottom Plenum Cap 240 and if CCMs 100 are stacked radially in each column, Middle Plenum(s) 230.

In one exemplary aspect of the invention, a 6.72-inch Diameter, 20.75 inch tall CEC “Cold-Can” enclosure 400 contains a CEC Coil Assembly 1000 comprising a four 3.25 inch diameter 3.38 inch tall CCMs 100 stacked axially in one column. In preferred embodiments, at least four CCMs are stacked, including exactly four in some embodiments, but more than four (e.g., 6, 8, etc.) in other embodiments. The CEC “Cold-Can” enclosure 400 comprises a Nipple 450 externally lined with a multi-layer-insulation (MLI) jacket 490 and internally lined with Insulation Sleeve 470 (FIG. 15) and an optional an MLI jacket (FIGS. 17A-17B) between the Nipple 450 and Insulation Sleeve 470. As is known in the art, MLI refers to an insulation comprising multiple layers of thin, highly reflective materials, typically metalized polymer films such as aluminized polyester (e.g. MYLAR®) or polyimide (e.g. KAPTON®), separated by a spacer material such as polyester netting or crinkled films, typically used in cryogenic applications and vacuum environments, and reduce heat transfer by reflecting both thermal and RF radiation. The Insulation Sleeve 470 and MLI jacket(s) 490 provide a very low emissivity to protect against electromagnetic radiation heat transfer between the ambient and the cryogenic cavity. In an exemplary embodiment, “low” or “very low” emissivity comprises measured emissivity in a range of 0.005 to 0.03. in accordance with the thermal model performance for NASA James Webb Space Telescope (JWST) MLI analysis. As is known in the art, emissivity is a measure of a surface's ability to emit thermal radiation, with values ranging from 0, for a perfect reflector, to 1, for a perfect emitter. Insulation Sleeve 470 has a low thermal conductivity (i.e. that meets G10 or G10-CR standards, such as in the range of 0.28-0.35. e.g. 0.293076 W/m·K (Watts per meter Kelvin)) and MLI jacket(s) 490 also has a low thermal conductivity (e.g. in a range of 0.15-0.18 W/m·K, such as for example, in one embodiment, 0.176 W/m·K). G10 Insulation Sleeve 470 has a electrical dielectric strength in a range of 500-800 volts/mil and is non-magnetic. The MLI jacket 490 has an emissivity range of 0.005 to 0.03. The CEC Coil Assembly 1000 is disposed in the Insulation Sleeve 470 where the Top Plenum Cap 220 press fits into the Insulation Sleeve 470 (FIG. 21). The CEC “Cold-Can” enclosure 400, often referred to as a “cold-can” is sealed by means of a bottom endcap that features instrumentation feedthrough (FIGS. 19A-19B) and a top endcap 410 that contains the Helium gas inlet port 412, gas recirculation exhaust port 413 and power feedthrough connections 414a-d mounted on a base 415 (FIGS. 18A-18B).

Maintaining the precise cryogenic environment is critical to the performance of the CEC Coil Assembly 1000 of which the CCM Core 120 design CCM Spacer 130 design, mechanical plenum designs, MIL jacket 490 designs and Insulation Sleeve design each play a part in maintaining the cryogenic environment. The CCM Spacer 130 provides dielectric separation and the structural support for the HTS Coils that make up the Double-Pancake HTS Coils 160. Additionally, the LSR in the CCM Spacer a50 and CCM Core 120 act as cooling plates for the Double-Pancake HTS Coils 160. In embodiments, the Bottom Plenum Cap 240 located at the bottom of the CEC Coil Assembly 1000 creates a gas flow plenum when the CEC Coil Assembly 1000 is assembled. Helium gas flows down the center of the CCM Core 120 and expands in the Bottom Plenum Cap 240 and provides separation for cooling gas to be dispersed across the CCM Spacer 130 and thereby across the face of the Double-Pancake HTS Coils 160 for uniform heat transfer and reducing “hot spots” (quench) across the surface the Double-Pancake HTS Coils 160. Helium gas is forced up through the CCM Spacers 130 and Double-Pancake HTS Coils 160 of each CCM 100. If stacked axially, the Middle Plenum encloses two CCMs 100 together to continue forcing Helium from one CCM 100 to the next CCM until Helium reaches the Top Plenum Cap 220 where the Helium exits the CEC “Cold-Can” enclosure 400. Using the various plenums reduces the space helium may travel within the CEC “Cold-Can” enclosure 400 as well as dictating the direction and flow of Helium thereby maximizing cooling and maintaining a constant cryogenic environment.

This modular approach enables the CEC Coil Assembly 1000 to have CCMs 100 stacked axially, wherein each magnetic field produced is inductively coupled, making the stacked CCMs 100 behave as a single additive magnetic field. When the CCMs are stacked radially or closely coupled side-by-side, the resulting ‘cluster’ configuration is inductively additive, facilitating large scale energy storage.

This invention creates a more compact design using solid state materials in a manner resulting in high density energy storage requiring less physical space. It is easily produced with low-cost manufacturing techniques and common materials in a highly scalable manner. The invention overcomes many previous design constraints when scaling to high energy storage densities by better symmetry, more uniform energy distribution and easier thermal management.

### BRIEF DESCRIPTION OF THE FIGURES

FIG. 1A is a perspective view depicting an exemplary compact energy cell (CEC) without a multi-layer insulation (MLI jacket and the CEC includes up to four CEC Coil Modules (CMM).

FIG. 1B is an isometric perspective view depicting the exemplary CEC of FIG. 1A.

FIG. 2A depicts an exploded view of an exemplary CEC containing a CEC Coil Assembly (CCA) having four CEC Coil Modules (CCM).

FIG. 2B depicts an exploded isometric view of the exemplary CEC of FIG. 2A.

FIG. 3A depicts an exploded view of an exemplary “Cold-Can” enclosure-style enclosure.

FIG. 3B—is an exploded isometric view of the exemplary “Cold-Can” enclosure-style enclosure of FIG. 3A.

FIG. 4A depicts an isometric view of an exemplary CEC Coil Assembly (CCA).

FIG. 4B is an exploded isometric view of the CEC Coil Assembly (CCA) of FIG. 4A.

FIG. 4C is an exploded perspective view of the CEC Coil Assembly (CCA) of FIG. 4A.

FIG. 5 depicts an isometric view of an exemplary configuration showing four axially stacked CEC Coil Modules (CCM).

FIG. 6A depicts a sectional view of a complete CEC illustrating components thereof and connectivity of a parallel circuit.

FIG. 6B depicts a sectional view of a complete CEC illustrating components thereof and connectivity of a series circuit.

FIG. 7 depicts a sectional view of an exemplary CEC Coil Assembly illustrating an exemplary fluid flow path, in which Helium gas enters a CCM Core and is redirected by a Bottom Plenum Cap to flow through CCM Spacers and Double-Pancake HTS Coils to exit a Top Plenum Cap.

FIG. 8 depicts a perspective view of an exemplary CEC Coil Module (CCM) depicted without a CCM Nut to illustrate an exemplary sunken Channel geometry of a CCM Core that prevents rotation of CCM spacers when mated with the Key geometry of the CCM Spacer.

FIG. 9 is an isometric view of an exemplary CEC Coil Module (CCM) Core.

FIG. 10A depicts an isometric view of an exemplary CEC Coil Module (CCM) Spacer.

FIG. 10B is a top view of the CEC Coil Module (CCM) Spacer of FIG. 10A.

FIG. 11 depicts an isometric view of a CEC Coil Module (CCM) depicted without a CCM Plenum Shell to illustrate exemplary electrical terminations within the CEC Coil Module.

FIG. 12 depicts an exploded view of an exemplary set of four plenum pin variations that when pressed into the slots of the CCM Spacers of FIG. 1A form an exemplary CCM Plenum Shell.

FIG. 13A depicts an exemplary Double-Pancake HTS Coil defined by a single strand of HTS Tape that is wound clockwise and counter clockwise.

FIG. 13B depicts the HTS coil of FIG. 13A wounded about two CCM Spacers, illustrating how CCM Spacers segregate the clockwise HTS Tape and the counter clockwise HTS Tape of the Double-Pancake HTS Coil of FIG. 13A.

FIG. 14 depicts two integrated Double-Pancake HTS Coil of FIG. 13A wounded about four CCM Spacers, illustrating how CCM Spacers segregate the layers HTS Tape and depicts where two Double-Pancake HTS Coils are terminated together.

FIG. 15 depicts an isometric view of an exemplary insulation sleeve depicting exemplary slots utilized to position a Top Plenum Cap of the CEC Coil Assembly of FIG. 4A.

FIG. 16 depicts an isometric exploded view of an exemplary complete CEC Coil Module.

FIG. 17A depicts an exemplary Multi-Layer-Insulation (MLI) Jacket that encapsulates the “Cold-Can” enclosure of FIG. 3A overlapping itself to eliminate gaps in the radiation protection.

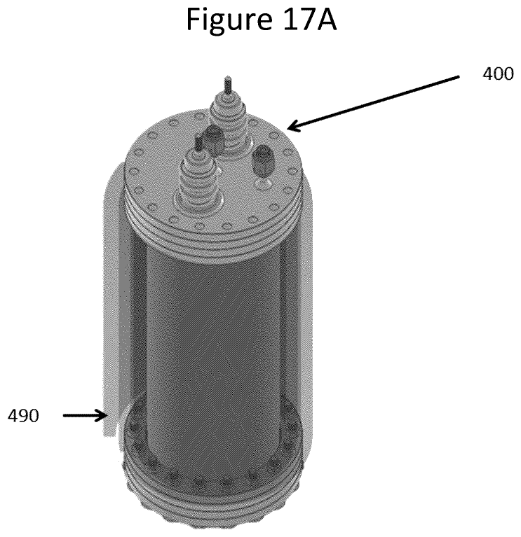

FIG. 17B is a top view depicting how the MLI jacket overlaps itself during assembly about the “Cold-Can” enclosure.

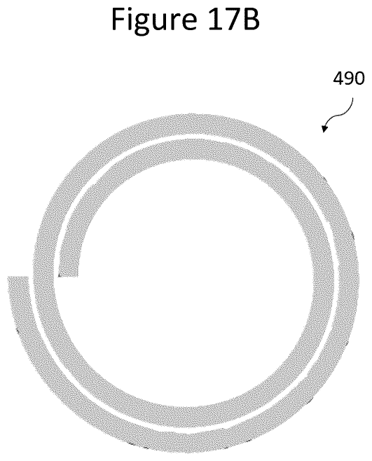

FIG. 18A depicts a perspective view of an exemplary Top End Cap Flange illustrating the power feedthroughs and gas inlet/outlets welded through a flange.

FIG. 18B-depicts an isometric view of the Top End Cap Flange of FIG. 18A illustrating the power feedthroughs and gas inlet/outlets welded through a flange.

FIG. 19A depicts an isometric view of an exemplary bottom endcap flange, illustrating electrical components that that provides instrumentation feedthrough for the “Cold-Can” enclosure of FIG. 3A.

FIG. 19B depicts an exploded perspective view of the bottom endcap flange of FIG. 19A, showing electrical components that that provides instrumentation feedthrough for the “Cold-Can” enclosure.

FIG. 20 depicts a perspective view of four columns of four axially stacked CEC Coil Modules by four columns of four axially stacked exemplary CEC Coil Modules to construct a cluster of 64 CEC Coil Modules in an exemplary CEC Coil Assembly.

FIG. 21 is a sectional view of an exemplary CEC displaying the press fit proximity of a Top Plenum Cap in the Insulation Sleeve of FIG. 15.

FIG. 22 depicts a perspective view depicting HTS Tape fed through the Top Plenum Cap of FIG. 21, illustrating where one end of the HTS tape is clamped to exemplary CEC Termination Clamps and threaded to the Electrical Feedthrough of the Top Endcap Flange 415 of FIG. 18A while the opposite end the HTS Tape is clamped to exemplary CCM Terminations of an exemplary CEC Coil Assembly.

FIG. 23 depicts a high-level CEC functional block diagram describing functionality of a general system including at least the CEC of FIG. 1A.

FIG. 24 is a schematic diagram of an exemplary quench protection circuit.

### DETAILED DESCRIPTION

In the following detailed description, numerous specific details are set forth by way of examples in order to provide a thorough understanding of the relevant design features. However, it should be apparent to those skilled in the art that the present design features may be practiced without such details. In other instances, well known methods, procedures, components, and circuitry have been described at a relatively high-level, without detail, in order to avoid unnecessarily obscuring aspects of the present design.

Additionally, various forms and embodiments of the invention are illustrated in the Figures. It will be appreciated that the combination and arrangement of some or all features of any of the embodiments with other embodiments is specifically contemplated herein. Accordingly, this detailed disclosure expressly includes the specific embodiments illustrated herein, combinations and sub-combinations of features of the illustrated embodiments, and variations of the illustrated embodiments.

Various terms are used throughout the disclosure to describe the physical shape or arrangement of features. A number of these terms are used to describe features that conform to a cylindrical or generally cylindrical geometry characterized by a radius and a center axis perpendicular to the radius. Unless a different meaning is specified, the terms are given the following meanings. The terms “longitudinal”, “longitudinally”, “axial” and “axially” refer to a direction, dimension or orientation that is parallel to a center axis. The terms “radial” and “radially” refer to a direction, dimension or orientation that is perpendicular to the center axis. The terms “inward” and “inwardly” refer to a direction, dimension or orientation that extends in a radial direction toward the center axis. The terms “outward” and “outwardly” refer to a direction, dimension or orientation that extends in a radial direction away from the center axis.

In the description, relative terms such as “horizontal,” “vertical,” “up,” “down,” “right”, “left”, “front”, “back”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation.

Terms concerning attachments, coupling and the like, such as “mounted,” “connected” and “interconnected,” refer to a relationship wherein structures are secured or attached to one another either directly or indirectly through intervening structures, as well as both movable or rigid attachments or relationships, unless expressly described otherwise.

In general, an inductor is a coil of electrically conductive material that stores energy in a magnetic field. They are used in circuits of various electrical devices but have significant limitations. Inductors have high electrical losses from joule heating because they eventually have high resistive losses, and convert electrical energy to heat as the current through the inductor increases. If the resistance can be eliminated using superconducting materials, then the joule heating losses are zero. Under these conditions, the energy storage density of inductors increases dramatically. High temperature superconductors (30-90 K) are now commercially available but the state of the art in creating and maintaining the environmental conditions to achieve superconductivity is complex, expensive, and not reasonably scalable for most desired applications.

Where very high pulses of energy are required to either be absorbed or delivered, inductors provide excellent utility. This is especially true for wind turbines, large scale solar battery storage systems, magnetic lift applications, imaging equipment, grid power quality and high energy pulsed lasers.

The invention provides a novel solid-state approach to producing a compact superconducting energy storage cell. The design uses low outgassing, low temperature liquid silicone rubber (LSR) with embedded G10 frame stiffeners to create spacers that provide strength and rigidity to protect the double-pancake coil windings from Lorentz forces produced by intense magnetic fields. The LSR spacers provide complete surface cooling to the double-pancake coil windings preventing hot spots (quench) and maintaining a constant cryogenic environment. The simple, modular, approach enables the CEC Coil Modules (assembly of two double-pancake coil windings) to be stacked axially, where each magnetic field produced is inductively coupled making the CEC Coil Modules behave as a single additive magnetic field. When the stacked CEC Coil Assemblies are closely coupled side-by-side then the resulting configuration is inductively additive creating large scale energy storage.

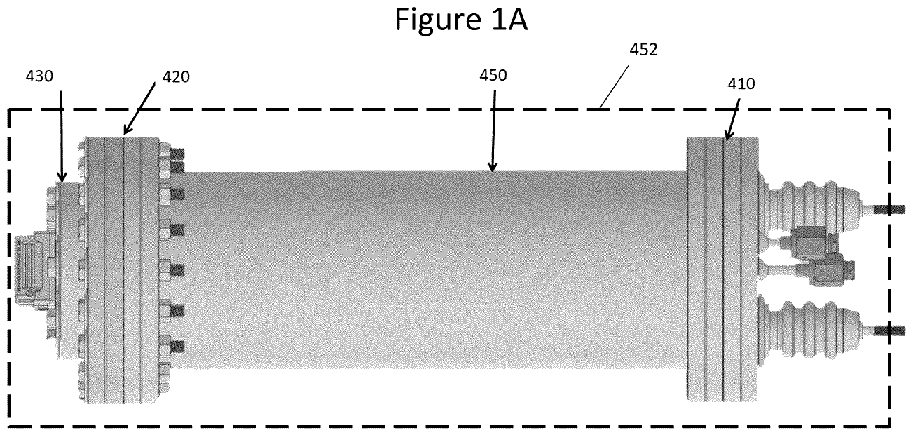

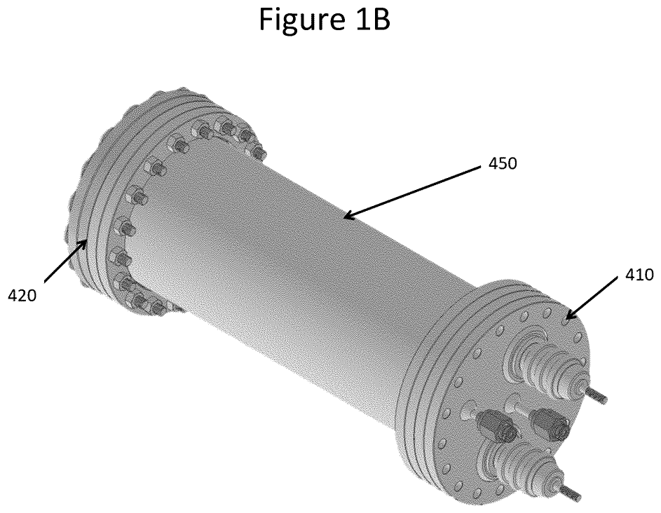

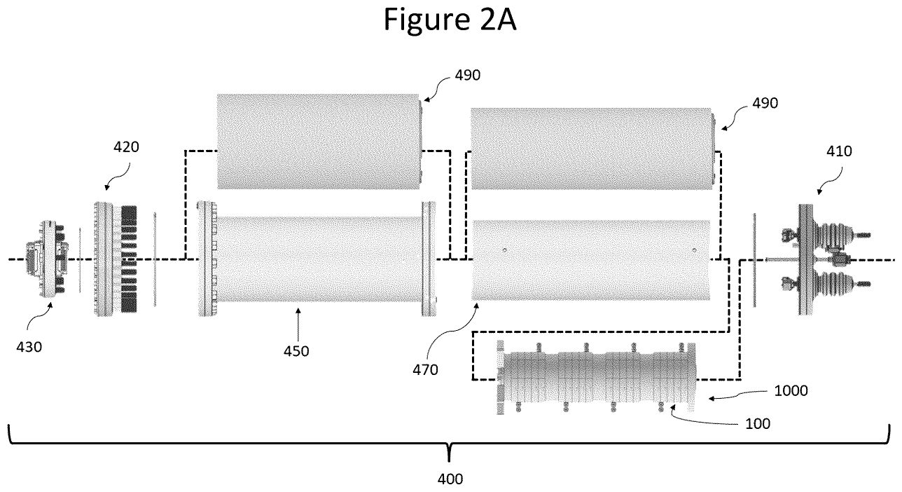

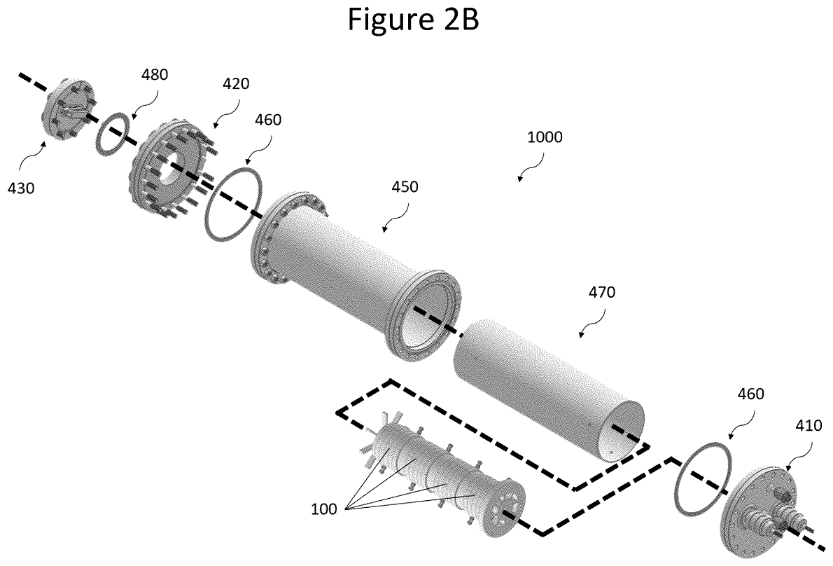

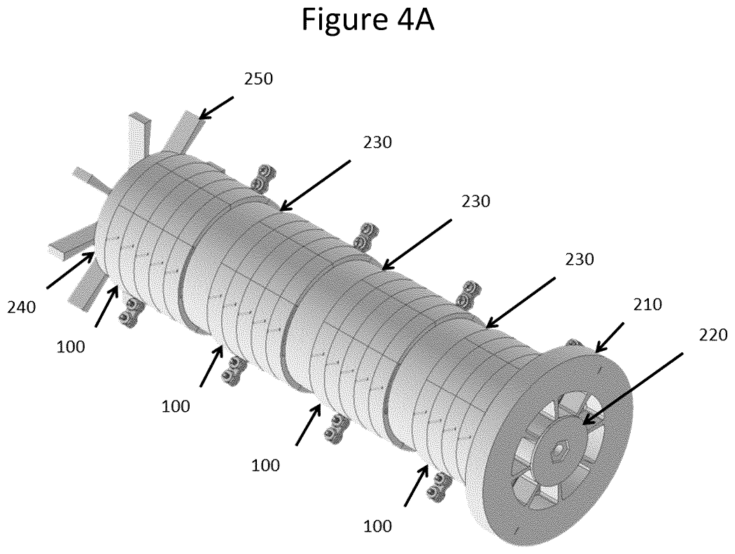

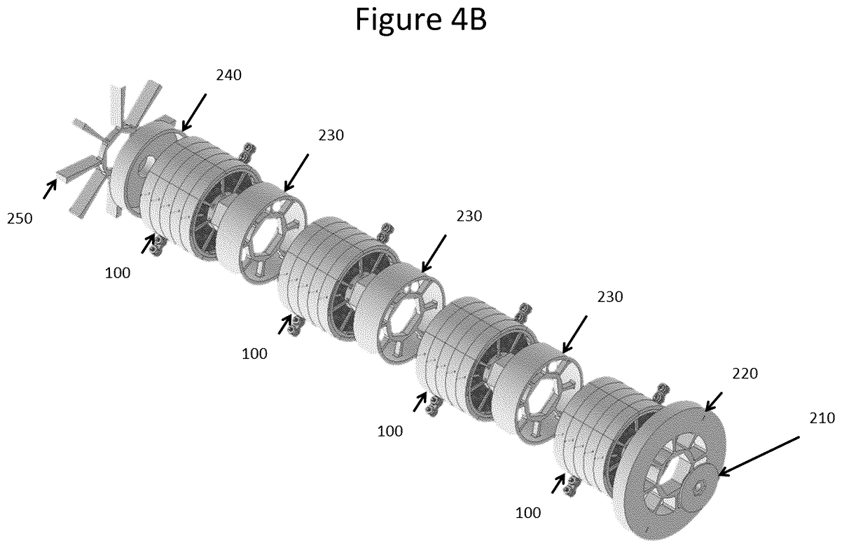

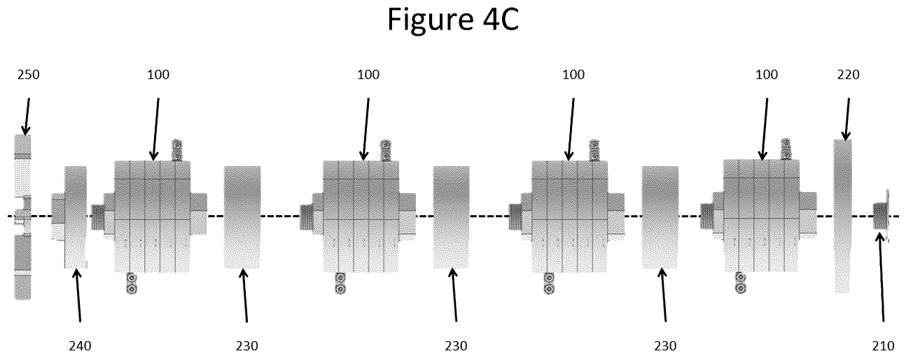

In an exemplary embodiment, the superconducting Compact Energy Cell (CEC) 400 contains at least one CEC coil assembly having 4 axially stacked CEC coil modules as shown in FIG. 4A. Each CEC coil 100 includes a CCM Core 120, two Double-Pancake Coils 160 made of high temperature superconductor (HTS) tape, surrounding the CCM Core 120 where each layer of the Double-Pancake Coil 160 is separated by a CCM Spacer 130. The CEC Coil Assembly is inserted into a G10 sleeve 470 as illustrated in FIG. 2B and is covered with a multi-layer insulation (MLI) jacket 490 and inserted into a double-walled cylinder 450 referred to as a “cold-can” as shown in FIG. 2B. The “cold-can” provides the cryogenic environment required for superconductivity of the CEC Coil Assembly. The “cold-can” 450 is sealed with at the top with an endcap flange 410 with Helium gas inlet/outlet ports 412/413 and electrical termination interfaces 414 and a bottom endcap flange 420 with an instrumentation feedthrough 430 providing temperature, voltage and magnetic field strength telemetry data. To achieve superconductivity, the CEC as shown in FIG. 1A is contained in a vacuum insulated enclosure (“vacuum vessel”) represented by dashed line 452. A cold can inserted into the vacuum vessel creating a structure in which the cold can wall and the vacuum vessel wall are separated by vacuum is commonly referred to as a Dewar or Cryostat. Exemplary vacuum vessels may be designed and constructed as is known in the art in any size or shape desired to accommodate the arrangement of CECs to be inserted therein. Although shown and described with an exemplary number of insulation layers, more insulation layers may be present (e.g. on an outer surface of the cold can), and each insulation layer may comprise a single layer, a plurality of discrete layers, a plurality of integrated layers, or a combination thereof, and the layers may be in the form of coatings applied to any of the applicable surfaces. Additional details regarding the individual components of CEC are discussed further below.

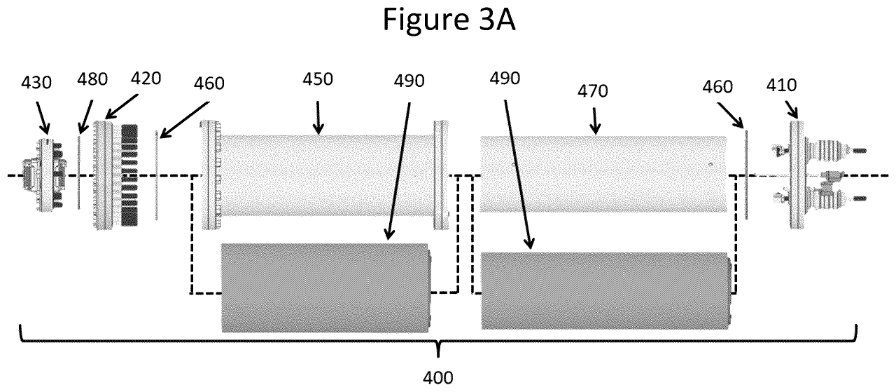

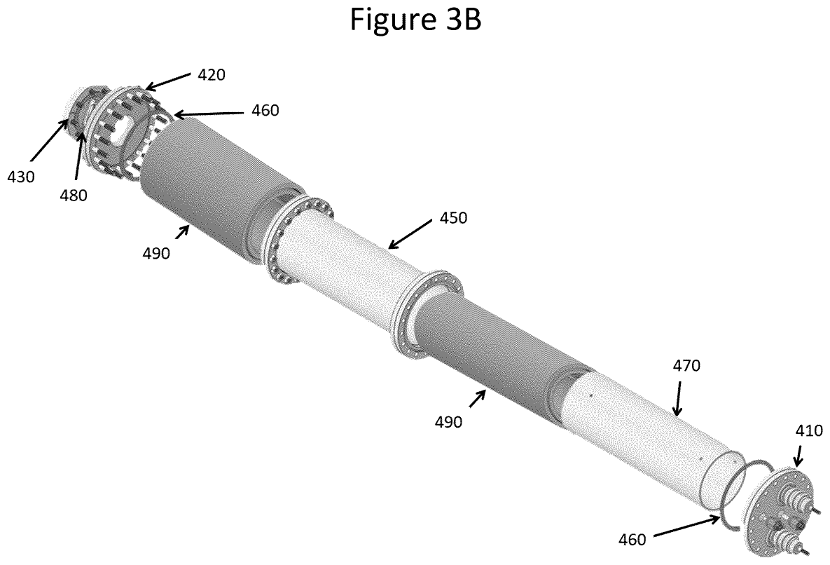

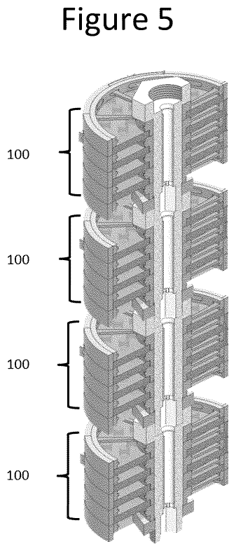

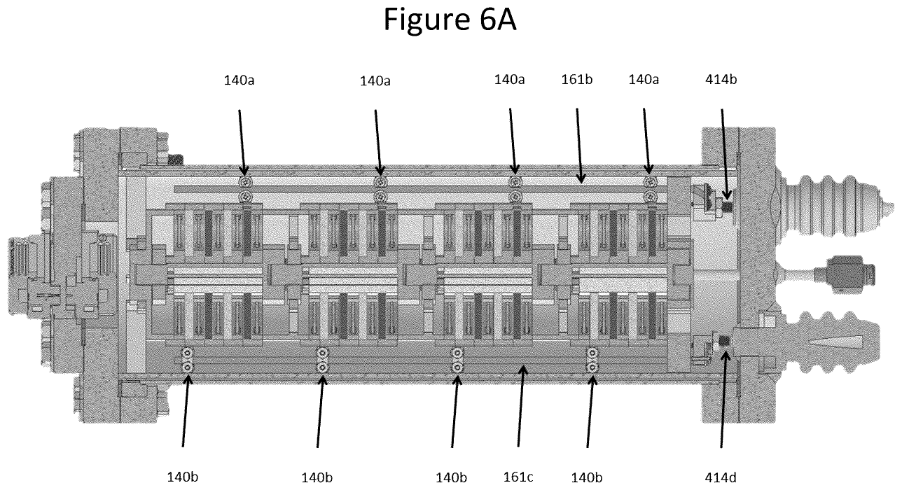

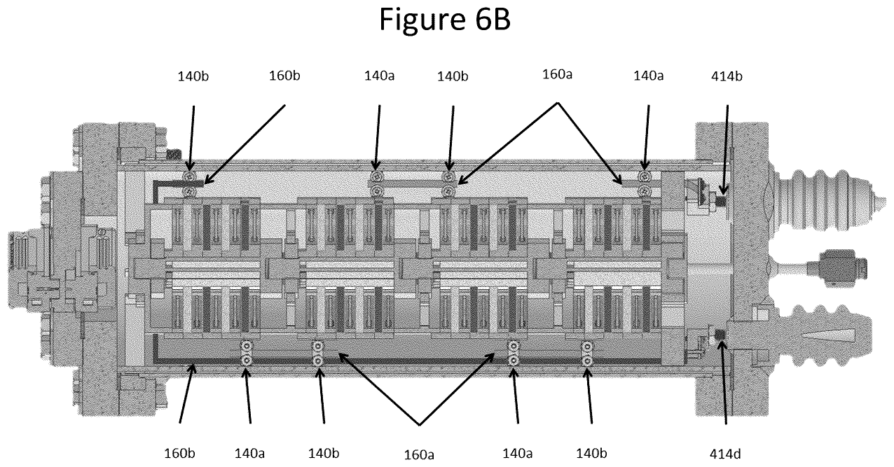

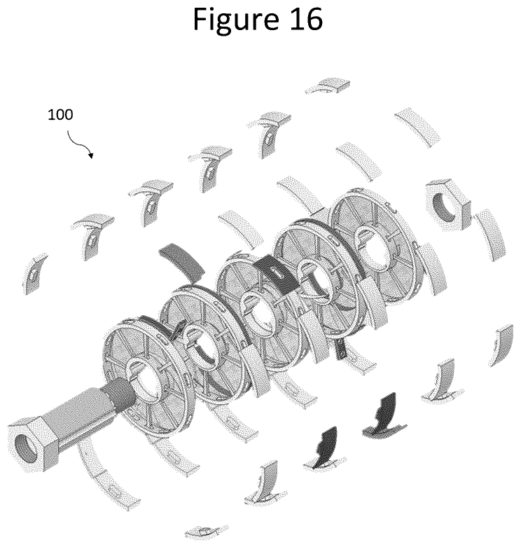

Referring to FIGS. 1A-1B, 2A-2B, 3A-3B, 7, and 16, the Compact Energy Cell (CEC) is comprised of a Helium gas cooled “Cold-Can” enclosure 400 that acts as a cryogenic container and a CEC Coil Assembly (CCA) 1000, as shown in FIGS. 4A-4C, that is a modular/scalable compact superconducting energy storage cell. In the exemplary embodiment shown in FIG. 1A and FIG. 6A, the “Cold-Can” enclosure 400 of the Compact Energy Cell is approximately 6.72 inches in diameter and 20.75 inches tall. The CCA 1000 containing four axially stacked CEC Coil Modules (CCM) is 4.48 inches in diameter and 12.75 inches tall. A single CCM measures 3.25 inches in diameter and is 3.38 inches tall. The stored energy of the exemplary Compact Energy Cell is nominally 3 KJ at 125 Amps to 4 KJ at 150 Amps, when the CCA 1000 containing four axially stacked CEC Coil Modules (CCM) are electrically connected in series, as shown in a non-limiting example of FIG. 5.

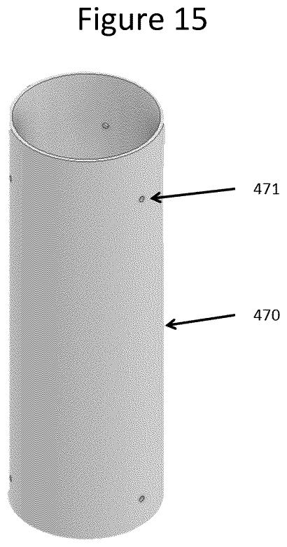

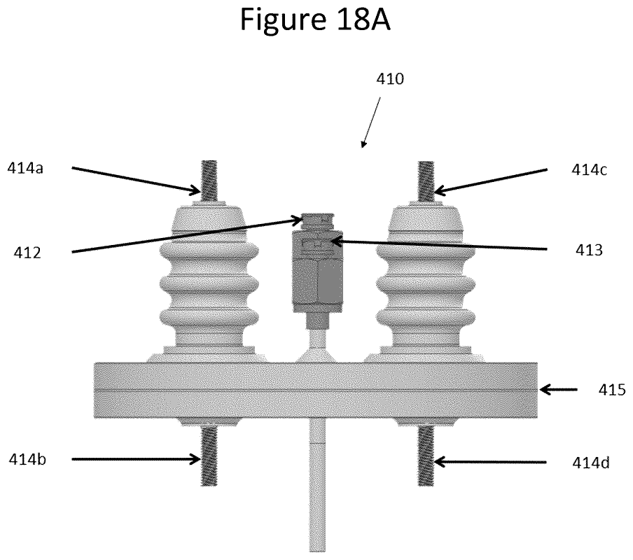

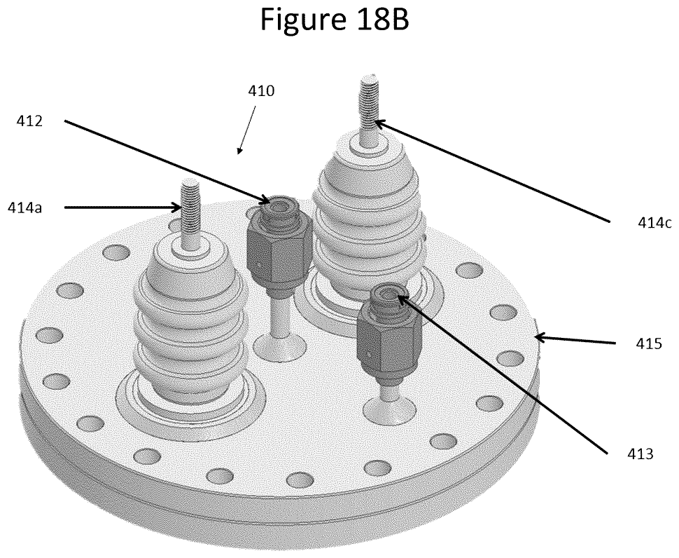

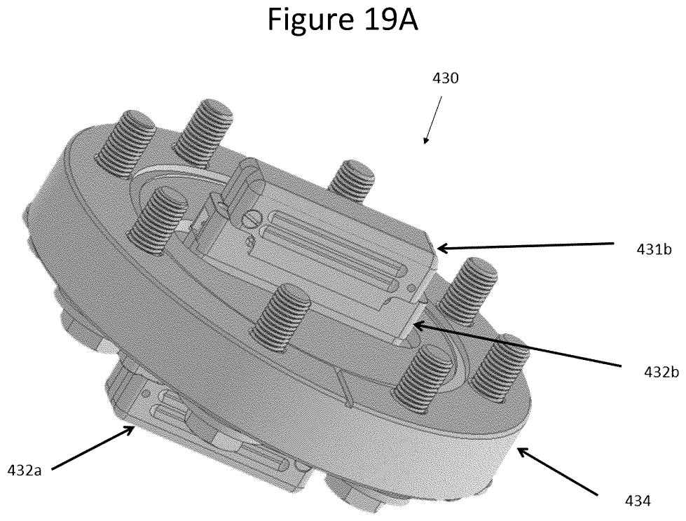

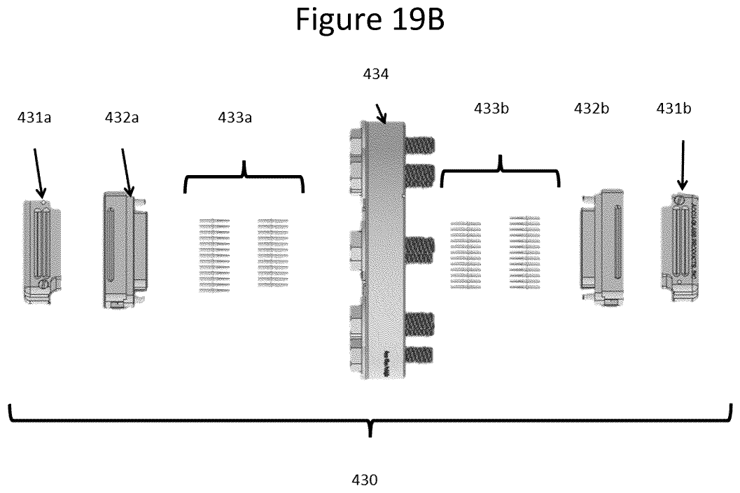

The “Cold-Can” enclosure 400 is comprised of a Top Endcap Flange 410 (FIGS. 18A-18B), Bottom Reducing Flange 420, Bottom Endcap Flange 430 (FIGS. 19A-19B), Nipple 450, Large Gasket 460, Insulation Sleeve 470 (FIG. 15), Small Gasket 480, Multi-Layer Insulation (MLI) Jacket(s) 490. Shown in FIG. 18B Helium Gas Inlet 412, Helium Gas Exhaust Outlet 413, and Two Electrical Feed-Throughs 414a,b and 414c,d were welded through the Top Endcap Flange 410. The exemplary embodiment shown FIGS. 6A-6B, to conduct electricity from the “Cold-Can” enclosure Input Termination 414b through the CCM(s) 100 and back to the “Cold-Can” enclosure Output Termination 414d the conductive material is compatible with (i.e. will not impact current output due to molecular interaction between dissimilar materials) an HTS tape, such as ReBC (Rare Earth-Barium-Copper-Oxide) second generation (2G) HTS 4-6 millimeter (wide) conductor tape, such as SCS4050 tape made by SuperPower Inc. (SPI) of Schenectady, NY, USA. As in known in the art, such tape comprises a multilayered buffer stack with an aligned crystal orientation in the direction of the metal substrate surface on which it is formed over the superconducting layer, and an optional copper stabilization layer over the silver overlayer.

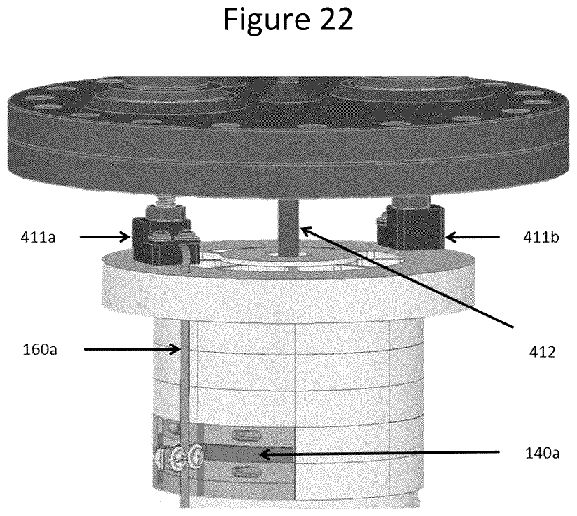

As shown in FIG. 22, for example, CEC Termination Clamps 411a, b, a threaded junction between the Electrical Feed-Throughs 414 and the HTS tape, is constructed from Copper. The orientation of the CEC Termination Clamps 411 may be adjusted to minimize the bend of the HTS tape acting as a straight busbar connection between the CCM(s) 100 and the Electrical Feed-Throughs 414. Similarly, the junction from the HTS tape and the CCM(s) 100 are also clamped. This allows for quick assembly and disassembly by reducing the amount of welding. Specially, this allows for components containing HTS tape to easily accessible and replaced in the event electrical faults are identified.

The exterior side of the “Cold-Can” enclosure Input Termination 414b and the “Cold-Can” enclosure Output Termination 414c, is connected to a HTS terminator such as the HTS terminator as described in U.S. Published Patent Application US20230291195A1, titled HIGH TEMPERATURE SUPERCONDUCTOR CABLE TERMINATION, assigned to the common assignee of the present invention, and incorporated herein by reference. A desirable HTS terminator prevents or minimizes joule heating from external conductions from migrating into the “Cold-Can” enclosure 400, a cryogenic chamber comprising of the CCA 1000, which would undesirably create added stress with respect to thermal management.

Thermal management inside the “Cold-Can” enclosure 400 is a combination of cryogenic helium, 30-55K, cycled through the “Cold-Can” enclosure 400 and the implementation of insulation. The Nipple 450 is externally lined with an overlapping multi-layer-insulation (MLI) jacket 490 and internally lined with Insulation Sleeve 470 and an optional MLI jacket 490 between the Nipple 450 and the Insulation Sleeve 470. The combination of the Insulation Sleeve 470 and the MLI Jacket(s) 490 have very low emissivity to protect against electromagnetic radiation heat transfer that occurs due to the large delta temperature between the ambient temperature and the temperature within the “Cold-Can” enclosure 400. In the exemplary embodiment, the Insulation Sleeve is constructed with Cryogenic G10, nonmagnetic material with a thermal conductivity value of at least 0.293076 W/m·K (° C./cm) with a dielectric strength of 500-800 volts/mil. Exemplary Cryogenic G10 materials includes but is not limited to Lamitex G10-CR and G11-CR Cryogenic Glass Epoxies as manufactured by Franklin Fiber-Lamitex Corp. As is understood in the art, G-10, G-11, G-10CR, G-11CR are all different variants of epoxy laminates and are defined in the National Electrical Manufacturing Association (NEMA) Specification “LI 1 Industrial Laminating Thermosetting Products” and in MIL-I-24768, with G-10 and G-11 often used interchangeably to mean G-10CR and G-11CR, respectively, but with the G-10CR and G-11CR grades having been specifically developed to provide uniform material properties at cryogenic temperatures. Using aforementioned HTS material, the preferred temperature range maintained inside the “Cold-Can” enclosure 400 is 45-55K.

Temperature within the layered structure of the CCM(s) 100 and inside the “Cold-Can” enclosure 400 is monitored using embedded Resistance Temperature Detector (RTD) sensors 133. Instrumentation and wiring to the RTD sensors occur through the Bottom Endcap Flange 430 constructed with a Type D feedthrough. Wires to the RDTs 133 are soldered to Feedthrough Pins 433b pushed into cryogenic adapter 432b and secured using backshell connector 431b. The exemplary configuration utilizes the Bottom Reducing Flange 420 to scale the diameter of the Bottom Endcap Flange 430 up to the Nipple 450 as shown in FIG. 2A.

The Insulation Sleeve 470 wrapped with an optional MLI Jacket 490 features slots 471 to insert short locating pins constructed as the same Cryogenic G10 material as the Insulation Sleeve 470, as shown in FIG. 15. The Top Plenum Cap 220, component of the CCA 1000, is press fit into the Insulation Sleeve 470; the locating pins stop the CCA 1000 into position without the touching the Two Electrical Feed-Throughs 414. The Top Plenum Cap 220 has two slots just large enough to feed the HTS tape from the CCA 1000 to the Two Electrical Feed-Throughs 414.

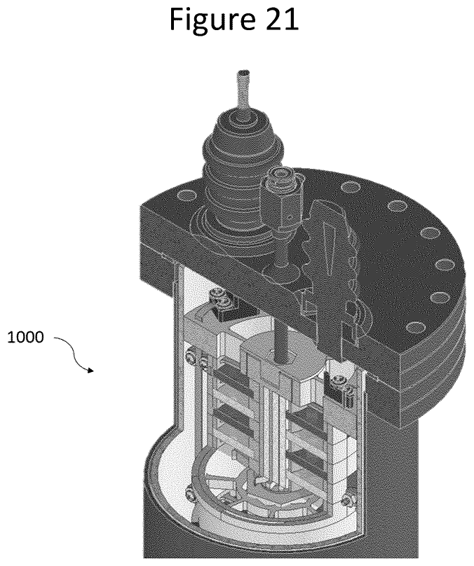

The CCA 1000 contains at least one CCM 100, one Top Plenum Nut 210, one Top Plenum Cap 220, one Bottom Plenum Cap 240, one Bottom Plenum Support 250. If more than one CCM 100 is in the CCA 1000, additional component Middle Plenum(s) 230 is also included. The seen in FIG. 21, Section View of CEC, the Top Plenum Nut 210 has a through hole allowing the Helium Gas Inlet 412 to be directly press fit into the CCA. The void in the “Cold-Can” enclosure 400 created above the Top Plenum Cap 220 allow the cycled Helium gas from the CCA to escape out of the “Cold-Can” enclosure 400 via the Helium Gas Exhaust Outlet 413. The Top Plenum Nut 210 and Top Plenum Cap 220 are constructed of cryogenic G10 material. The Top Plenum Cap 220 is a loose press fit to the hex head feature in the CCM Core 120, a component of the CCM 100. To secure the Top Plenum Cap 220 onto the CCM, the Top Plenum Nut 210 threads into the hex head of the CCM Core 120 as shown in FIG. 21.

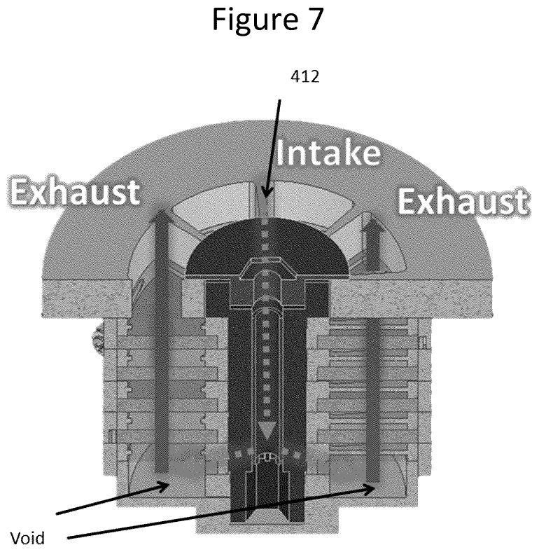

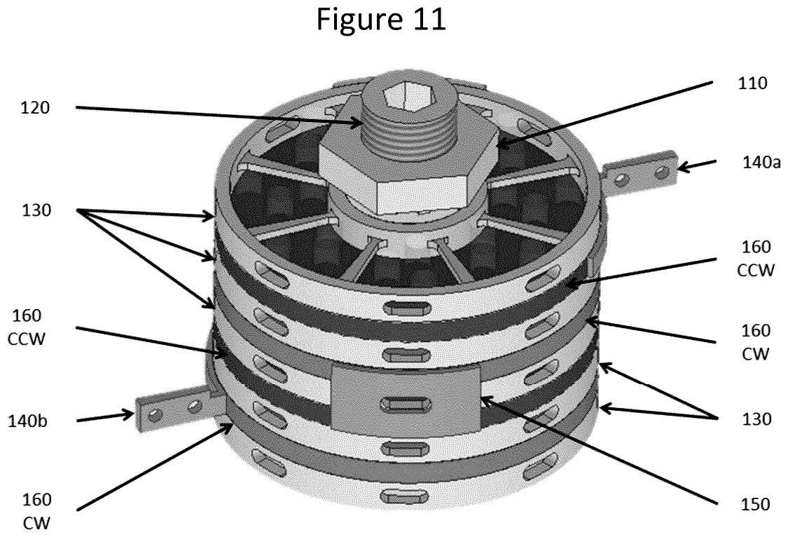

The Bottom Plenum Cap 240 is threaded to the bottom length of the CCM Core 120. As shown in FIG. 7, the Bottom Plenum Cap 240 directs the flow of Helium gas (Intake) to a void below the CCM Spacer 130, component of the CCM 100). The Bottom Plenum Cap 240 and the Bottom Plenum Support 250 are constructed from cryogenic G10 material. The Bottom Plenum Support 250 is a tight press fit to the hex head feature on the exterior of the Bottom Plenum Cap 240 but a loose press fit to the inside diameter of the Insulation Sleeve 470. The Bottom Plenum Support 250 provides radial support to the bottom of the CCA 1000 to ensure the CCA 1000 remains concentric with the “Cold-Can” enclosure 400. If the CCA 1000 were to shift within the “Cold-Can” enclosure 400, the electrical terminations of the CCM 100 (FIG. 11) could contact the walls of the “Cold-Can” enclosure and either become damaged or reduce the efficiency of the CCA 1000.

Constructed from cryogenic G10 material, the Middle Plenum 230 is a loose press fit to the hex head feature in the CCM Core 120, similar to the Top Plenum Cap 220. The Middle Plenum is only implemented when CCM(s) 100 are axially stacked. Without the Middle Plenum 230, Helium gas would escape the boundaries of the CCA 1000 and resulting convection of the Helium gas inside the “Cold-Can” enclosure 400. The Middle Plenum 230 limits the path of Helium gas to flow directly from one CCM 100 to the next thus ensuring Helium gas flows through each CCM 100 through the Top Plenum Cap 220 and cycles out of the “Cold-Can” enclosure 400 via the Helium Gas Exhaust Outlet 413.

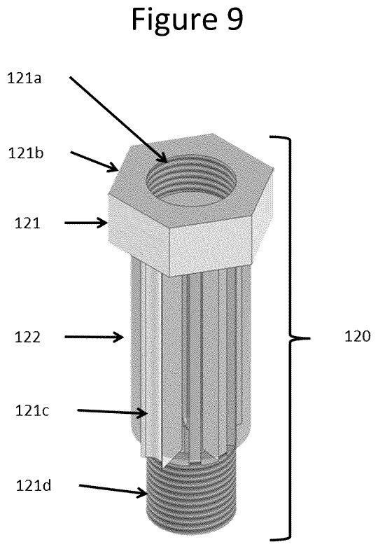

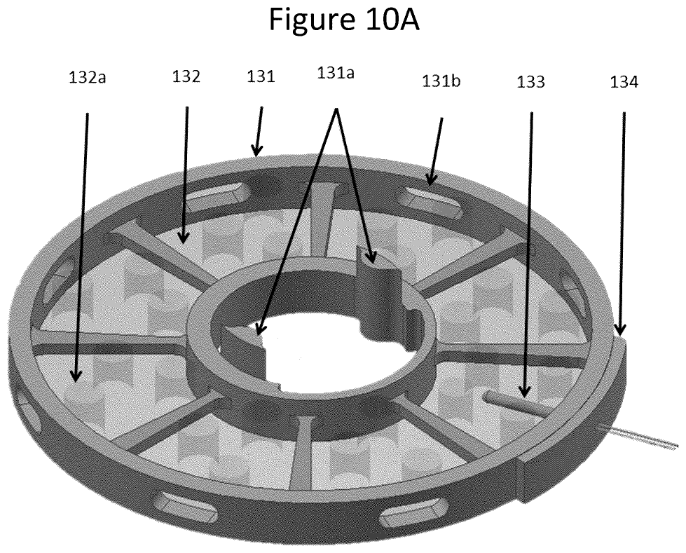

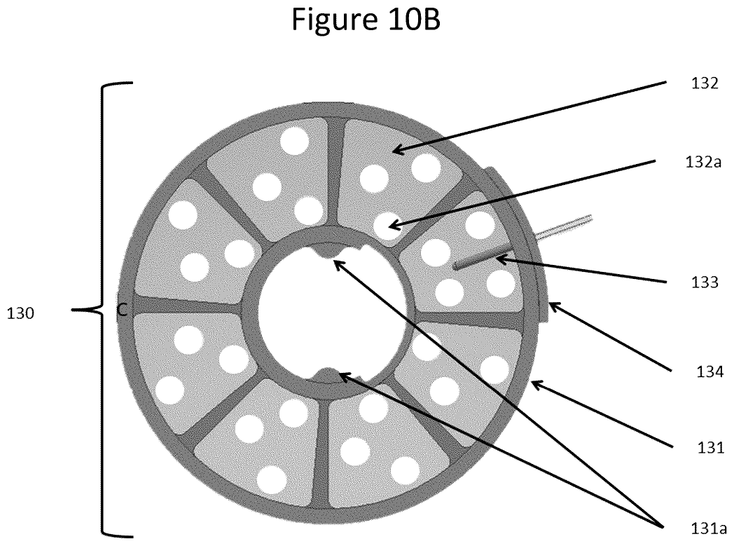

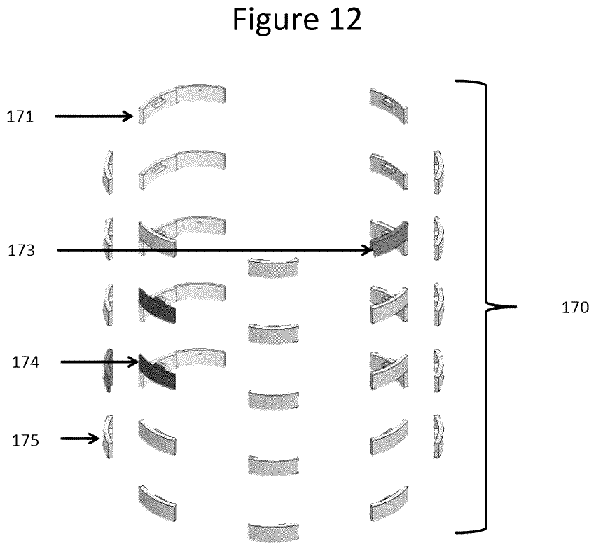

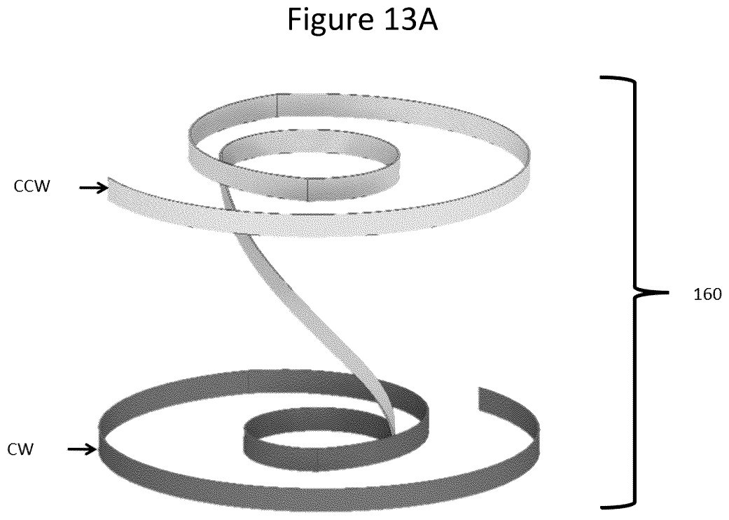

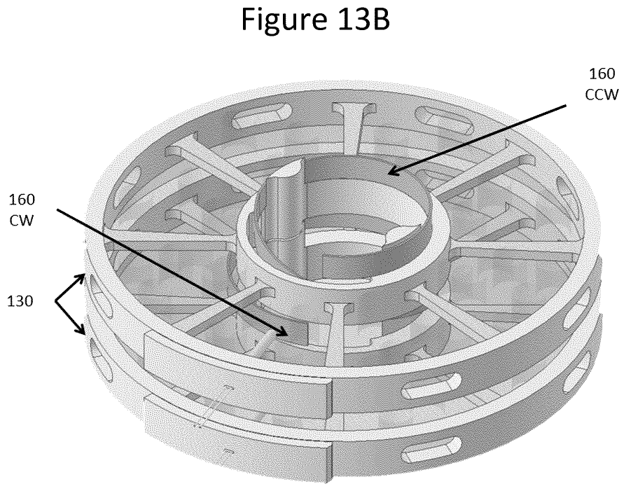

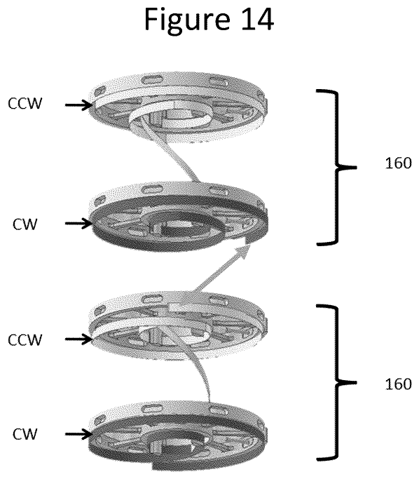

The modular component that stores the energy of the Compact Energy Cell is the CCM 100. As shown in FIG. 11A, the CCM 100 has seven components: 1) CCM Nut 110, 2) CCM Core 120 (FIG. 9), 3) five CCM Spacers 130 (FIGS. 10A-10B), 4) two CCM Terminations 140a and 140b, 5) CCM Busbar 150, 6) two HTS Double-Pancake Coils 160 (FIGS. 13A-13B and 14), and 7) an arrangement of CCM Plenum Shell 170 (FIG. 12). The CCM Nut 110 is constructed of Cryogenic G10 material. As shown in FIG. 11, the purpose of the CCM Nut 110 is to secure the five CCM Spacers 130 onto the CCM Core 120. The CCM Core 120 is a CCM Stiffener Core 121, of a Cryogenic G10 material that includes the following: embedded threaded hex nut 121a/121b at the top of the core, sunken key channel to accept the key 131a at the center of the coil spacer 131, and the threaded end 121d of the CCM stiffener core 121 used to secure subsequent CCM 100 modules to create an axially stacked CCM as depicted in FIG. 5. The stiffener core 121 is encapsulated in the CCM LSR Core 122, a low outgassing low temperature liquid silicone rubber (LSR) 122 with a 60-80 SHORE A durometer. Likewise, the CCM Spacer 130 is a CCM Stiffener Spacer 131, Cryogenic G10 stiffener, and an RTD sensor 133 encapsulated in the CCM LSR Spacer 132, a low outgassing low temperature LSR with a 60-80 SHORE A durometer. To position the RTD Sensor 133 consistently in the CCM LSR Spacer 132, RTD Plenum Pin 134 is used. The RTD Plenum Pin 134 constructed of Cryogenic G10 material and is press into the side of the CCM Spacer 130.

At room and cryogenic temperatures, the structure of the CCM Nut 110, CCM Stiffener Core 121, CCM Stiffener Spacer 131, Top Plenum Nut 210, Top Plenum Cap 220, Middle Plenum 230, Bottom Plenum Cap 240, Bottom Plenum Support 250, Isolation Sleeve 470 and its locating pins shall be maintained as they shall expand and contract due to identical material construction, Cryogenic G10.

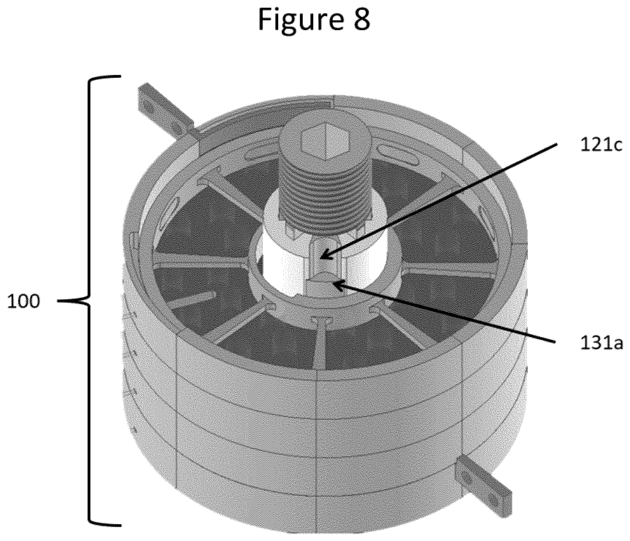

As depicted in FIGS. 10A and 10B, the CCM Stiffener Core 121 and the CCM Stiffener Spacer 131 provide rigidity to the CCM LSR Core 122 and CCM LSR Spacer 132 respectively. At low temperatures the LSR material becomes permeable to Helium gas. To allow Helium gas to flow through the CCM Spacers 130 before the LSR material reaches permeability, the CCM LSR Spacer utilizes 25 evenly spaced through holes 132a. In the exemplary embodiment, the 25 holes are aligned between each of the five CCM Spacers 130, maximizing airflow. Hole alignment or hole misalignment is dictated by orientation of keys 131a of the CCM Stiffener Spacer 131 within mating channel grooves 121c of the CCM Stiffener Core 121 (See, e.g., FIG. 8). This alignment feature not only controls the CCM LSR Spacer 132-hole alignment but also prevents any rotational movement of the CCM Spacer 130. In addition to the Bottom Plenum Cap 240 and Middle Plenum 230 to channel helium gas through the CEC Coil Assembly, each Coil Module has a side plenum that surrounds the surface of the coil module to channel helium gas for additional cooling. The plenum voids 131b illustrated in FIG. 11A is for the placement of the plenum pins 175 illustrated in FIG. 12. FIG. 8 illustrates the coil module will all plenum pins 175 installed on each of the coil spacers 130.

The CCM 100 can be axially stacked, aforementioned above, without additional components. The head of the CCM Core 120 is a hex nut and the bottom length has a complementary thread. This threaded connection allows the intake of Helium gas to flow freely from the Top CCM 100 to the bottom CCM 100 due to the hallow geometry of the CCM Core 120 shown in FIG. 5. The hex body of the CCM Core 120 provides flat locations to grip the CCM Core while screwing on a CCM Nut 110 and when axially stacking CCMs 100 together. Note, the Middle Plenum 230 is not necessary to axially stack CCMs 100 but it is included during axial assembly to ensure the cooling medium, cryogenic Helium gas, flows directly from one CCM 100 to the next.

Inside the “Cold-Can” enclosure 400, cryogenic temperature is maintained when the LSR is a glass state (Tg) and act as cold plates to the Double-Pancake Coils 160 and providing additional structural support to the CCM Core 120 and CCM Spacers 130. The low durometer of the LSR, 60-80 SHORE A, allows for the absorption of any Lorentz forces generated by the Double-Pancake Coils 160 and accommodates the differences in thermal expansion coefficients between the LSR and superconductor materials.

Using a “winding jig” developed and proprietary to NDI Engineering Company, high temperature superconductor (HTS) tape is wound about the CCM Core 120 in the voids formed by the axially stacked CCM Spacers 130 to create two Double-Pancake Coils 160 that are uniform in length and coil tension. FIG. 13B illustrates how the geometry of a single Double-Pancake Coil 160 where the HTS tape layers are separated using two CCM Spacers 130. FIG. 14 illustrates the geometry of Double-Pancake Coils 160 connected in series where each layer of HTS tape is separated by a CCM Spacer 130.

HTS tape ends 161b and 161c shown in FIG. 11, are welded together using CCM Busbar 150 to connect the Double-Pancake Coils 160 in series. The opposite ends, 161a and 161d shown in FIGS. 6A-6B, of the two Double-Pancake Coils 160 are each welded to a CCM Termination 140. Each CCM Termination 140 are clamped to the HTS tape being used as a conductor to connect the CCMs 100 and to the Electrical Feed-Throughs 414. FIG. 6A show four CCMs 100 in a parallel circuit to the Electrical Feed Throughs 414. FIG. 6B show four CCMs 100 in a series circuit to the Electrical Feed Throughs 414. Specifically, FIG. 6B shows busbar 160a which is configured to connect to the CCM Terminations 140a and 140b (“a” and “b” denote positive and negative polarity).

CCM Busbar 150 and CCM Termination 140 are machined from copper to maximize electrical conductivity. Tension of the HTS coils are maintained during the welding process using various press fit CCM Plenum Shell 170 (specific combination and orientation of five Plenum Pin 90 DEG 171, two Plenum Pin Termination 173, two Plenum Pin Busbar 174, and twenty-six Plenum Pin 45 DEG 175 shown in FIG. 12). The press fit of CCM Plenum Shell 170 shall not be compromised at cryogenic temperatures as they are constructed as the same Cryogenic G10 material as the CCM Spacer 130 and therefore all components shall expand and contract the same rate. As shown in FIG. 11 and FIG. 12, the CCM Plenum Shell 170 entirely enclose the outside diameter of the CCM Spacers 130 and Double-Pancake Coils 160 thereby preventing Helium Gas flowing outside the CCM 100 and directing the flow of helium Gas through each CCM Spacer 140 and each layer of wounded HTS tape.

When assembled in the configuration described according to the embodiments discussed above, (CCA 1000 containing four are axially stacked CCM 100), CCMs 100 provide improvements with respect to energy storage density of, particularly in connection with high temperature superconductors (30-90 K). Improvements apply to a variety of applications, including but not limited to, wind turbines, large scale solar battery storage systems, magnetic lift applications, imaging equipment, grid power quality and high energy pulsed lasers. Additional applications are listed below:
Energy Storage
Load Following
System Stability
Automatic Control Generation
Spinning Reserve
Reactive volt-ampere (VAR) control and power factor correction
Black Start Capacity
Bulk Energy Management
Transient Voltage Dip Improvement
Dynamic Voltage Stability
Tie Line Control
Under-frequency Load Shedding Reduction
Circuit Break Reclosing
Power Quality Improvement
Backup Power Supply
Sub-synchronous Resonance Damping
Electromagnetic Launcher
Wind Generator Stabilization
Minimization of Power and Voltage Fluctuations of Wind Generator
Battery Energy Storage System (BESS) overload safety

Superconducting Magnetic Energy Storage (SMES) devices are typically relegated to large-scale applications which can be costly and inherently difficult to operate under safe conditions. The CCA 1000 that comprise individual CCMs 100 improve on the cost, safety and complexity of scaling superconducting inductors, because they are smaller and easier to manufacture.

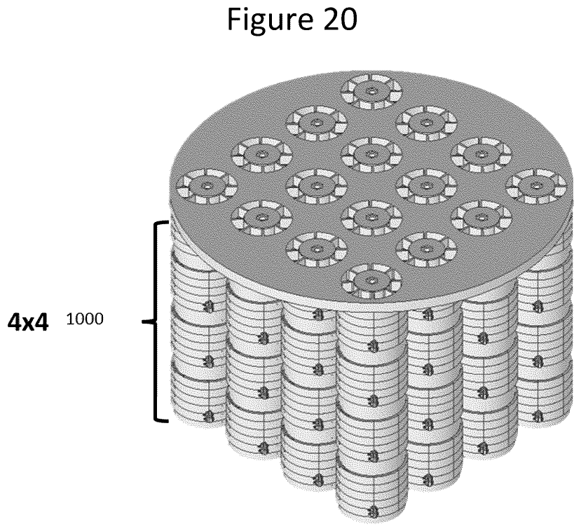

These benefits are achieved, in part, by using LSR-based structures (CCM Core 120 and CCM Spacer 130). The simple, modular, approach enables the CCM 100 to be stacked axially, where each magnetic field produced is inductively coupled, thereby making the stacked coils behave as a single additive magnetic field. When CCM 100 radially stacked (closely coupled side-by-side in a lateral or ‘cluster’ arrangement shown in FIG. 20, for example) is inductively additive, creating large scale energy storage. Extemporary radially stacked CCA configuration containing 64 CCMs 100 is shown in FIG. 20 where sixteen columns of four axially stacked CCMs 100 are clustered together. Thus, an exemplary superconducting CEC is configured to support clustering of multiple CCAs to provide scalability of power output. This modular approach facilitates construction of an arbitrary size vacuum vessel configured to contain the number and arrangement of CCAs to be clustered. As used herein, the term CEC may refer to a single CCA and surrounding structures, or a cluster of CCAS.

Furthermore, the building block approach to the CCM 100, as shown in FIG. 11, reduces localized adverse forces on the HTS Double-Pancake Coils 160 created by the increasing magnetic field density (Lorentz forces). The CCM 100 provides a symmetrical geometry that makes the magnetic field strength and flux density gradient across the two Double-Pancake Coils 160s more uniform, thereby making cooling simpler and more reliable.

Moreover, the molded Liquid Silicone Rubber (LSR) structures of the components of the CEC Coil Module 100 provide the necessary electrical and thermal protections necessary to maintain complex, inter-dependent superconducting parameters. These inter-related superconductivity parameters have critical limitations regarding temperature, current and magnetic flux density, such that the physical symmetry of the radially stacked CCMs 100, depicted in FIG. 20, creates uniform inductive coupling of the magnetic fields where the energy is stored. This uniformity reduces the magnetic field flux gradient across the aggregated coils and makes it easier to keep the coils in a superconducting state. In one non-limiting example, a CCA 1000 containing a single CCM 100 may be rated for 250 Joules, such that a CCA 1000 containing four axially stacked CCMs 100 connected in series would be rated for 1 Kilo-Joules.

Further, it is desirable to protect against radiation heating from the ambient and conductive heating from the interface between the CEC Coil Assembly 1000 and external systems, e.g. external wiring. The conductive heating from the external wiring can be minimized by incorporating a high temperature superconductor cable termination, as discussed in more detail in the U.S. patent application Ser. No. 18/118,522 (published as US2023-0291195), which his incorporated herein by reference. In an exemplary embodiment, as disclosed in the '522 application, a high temperature superconductor cable termination system 200A ('522 application) has an electrical generator 410A ('522 application) is driven to generate power, which is then input to a high temperature superconductor cable termination system 200 ('522 application). The electrical power flows through electrical output lines 206 ('522 application) and into cold can 202 ('522 application) of section 300B ('522 application) for cryocooling. In the exemplary embodiment, the CCA 1000 containing stacked CCMs(s) 100 housed in “Cold-Can” enclosure 400 without internal losses. Additionally, or optionally, in a CCA 1000 containing clusters of stacked CMMs(s) 100 can be connected in parallel to scale to great numbers, thereby satisfying applications that bridge small scale and large-scale applications, without running into the limitations created by Lorentz forces or adverse implementation costs.

Thus, according to an embodiment of the invention, a High Temperature Superconducting (HTS) Cable Cooling System is provided. The HTS Cable Cooling System includes a first chamber having disposed therein the cryogenically sealed chamber (“Cold-Can” enclosure 400) comprising a single CCA 1000 as described herein and one or more refrigerant lines configured to feed cooling medium (cryogenic Helium gas) into the “Cold-Can” enclosure 400 via the Helium Gas Inlet 412. The cooling medium is configured to absorb heat from the “Cold-Can” enclosure 400. The HTS Cable Cooling System also includes a second chamber connected to the first chamber, the second chamber having disposed therein a heat exchanger thermally coupled to the one or more refrigerant lines (source of cooling medium) and configured to extract heat from the gas refrigerant. A vacuum pump is connected to and configured to create a vacuum within both the first chamber and the second chamber. A cold head is disposed within the second chamber and configured to receive coolant from a cryogenic cooler connected to the cold head. The cold head is thermally coupled to the one or more refrigerant lines in the heat exchanger. A compressor is configured to compress the refrigerant and output the compressed refrigerant into the one or more refrigerant lines. A heat recuperator is in the second chamber and thermally coupled to the one or more refrigerant lines receiving output from the compressor. The heat recuperator is configured to recuperate heat from the compressed refrigerant, wherein the cooling medium comprises Helium gas.

Thus, the Compact Energy Cell (CEC) comprises a CCA 1000 protected by Insulation Sleeve 470 wrapped in an MLI Jacket 490 which is contained in a “Cold-Can” enclosure 400 that is wrapped in an MLI Jacket 490 addresses and provides a solution to the considerations related to an SMES inductor: (1) creating and maintaining the temperature regime for superconducting purposes; (2) configuring and managing the magnetic field orientation and flux density such that they are inductively amplified instead of cancelled; and (3) safety of the equipment and personnel if the superconductor goes back to normal more (no longer superconducting), i.e. a quench. Providing quench protection can be expensive and complex. The Compact Energy Cell (CEC) provides a more uniform magnetic field also results in a lower refrigeration capacity need since, once a superconducting state is achieved there are no internal losses generated to remove heat from.

Connecting the CCM 100 radially (cluster) results in a magnetic field shape of a toroid with a single north and South Pole emanating out and in the ends of the radially aligned HTS Double-Pancake Coils 160. This addresses the uniformity for the HTS Double-Pancake Coils 160 radially, but it creates a flux gradient laterally. Closely coupling the coil stacks axially provides an additive magnetic inductance that evens out the magnetic fields everywhere except the outer circumference of the axially stacked CCMs 100. Thus, a single large inductor, CCA 1000, is formed by integrating a series of smaller inductor modules, CCM 100, without the flux gradient laterally. This reduces the risk of hot spots (quench) throughout the combined inductor while simultaneously dramatically increasing the potential for stored energy.

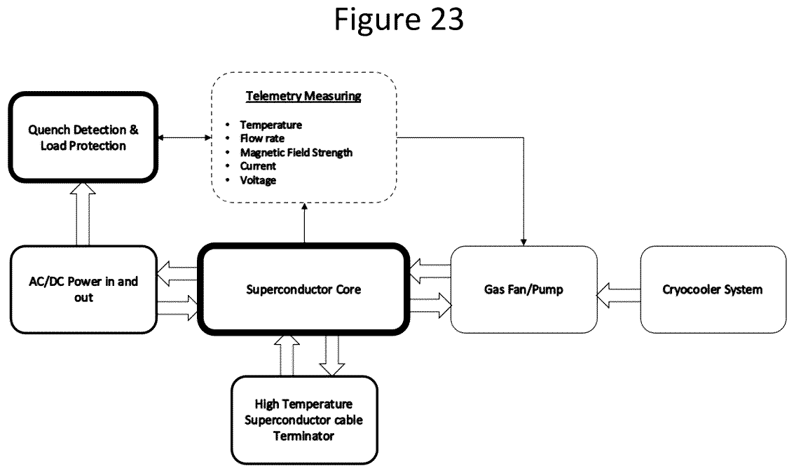

Use of the superconducting CCM 100 as described herein in various systems may generally include control and operation as depicted in FIG. 23, CEC functional block diagram, which may be tailored to a specific application. The diagram depicted in FIG. 23, CEC functional block diagram, represents a high-level functional block diagram that identifies general system functionality implemented by the invention in any particular application. Aspects of the invention primarily focus on the scalable compact Superconductor Solid State Inductor Module, CEC, and its protection, which may comprise the heart of an energy storage application. The circuitry around the CEC will be application specific and related to how energy needs to be stored and subsequently delivered to a circuit load.

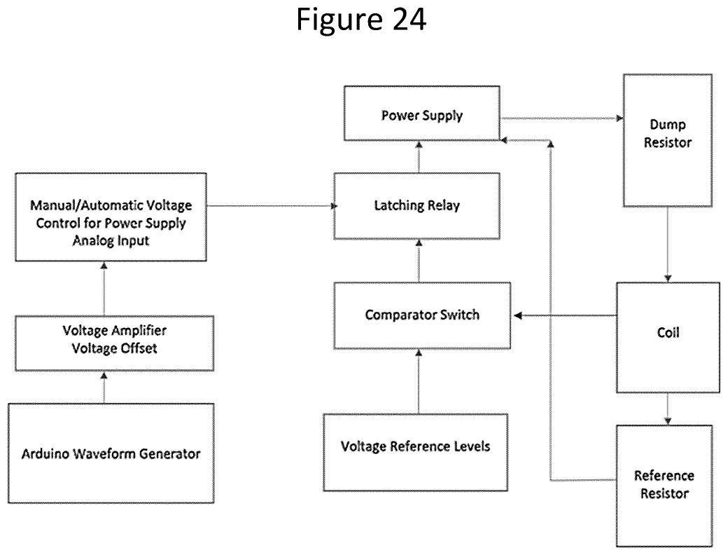

In general, however, maintaining a superconducting environment for the Double-Pancake HTS Coils 160 is a complex operating envelope consisting of interaction amongst the magnetic field flux density, critical current and critical temperature. Embodiments may include an exemplary quench circuit, as schematically depicted in FIG. 24, that provides quench protection to monitor and control these properties, with feedback loops, to operate continuously and safely within the envelope. Primarily, energy in the magnetic field of the coils are at a devalued level below the theoretical maximum level. This provides a safety margin. Inevitably, quench events may occur under adverse conditions, so if the algorithm monitoring critical current, temperature and flux density detects a potential impending quench, an external resistive dump load is used to protect the superconducting elements and other external equipment. The unique quench detection and protection algorithm and circuit features enable safe module operation for a vast range of AC and DC waveforms of input energy. Energy is stored and transferred at essentially zero loss, typically 0.01% to 0.1% of the stored energy due to the unique design of the Coil Module 100 and stacked Coil Assembly 1000 to maintain a regulated cryogenic environment. The quench algorithm circuit features monitor the CCM 100 for current, temperature and gas flow rate with an algorithm to determine when a quench event is occurring and safely dumps the stored magnetic field energy. Once the fault is removed, the system will recharge.

Creating a more uniform magnetic field also results in a lower refrigeration capacity need since, once a superconducting state is achieved there are no internal losses generated to remove heat from. The challenge of maintaining sound heat transfer techniques for conduction, convection, and radiation must be addressed. Conduction and convection challenges are managed with solid state encapsulation while radiation is managed by moving the concern to the outer perimeter then using retroreflective materials to manage. In this way, multiple components of the CCM 100 comprise LSR, which becomes permeable to Helium gas at cryogenic temperatures. Accordingly, the electrical isolating CCM Spacers 130 between the Double-Pancake HTS Coils 160 provide no meaningful resistance to the Helium gas flow, thereby increasing the rate and uniformity of heat transfer and thus reducing the cooling need and increasing safety margin from a quench.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed:

1. A superconducting compact energy cell (CEC) comprising:
a cold-can nipple defining an enclosure and having a top endcap and a bottom endcap, the enclosure containing:
at least one CEC Coil Assembly (CCA) having a plurality of axially stacked CEC Coil Modules (CCMs), each CCM comprising a set of two, double-pancake High Temperature Superconductor (HTS) coils circumferentially surrounding a CCM core, each pancake layer of each double-pancake HTS coil separated by a CCM spacer;
an insulation sleeve disposed about the CCA;
a multi-layer insulation (MLI) jacket disposed about the insulation sleeve; and
a jacket disposed about the cold can nipple.

2. The CEC of claim 1, wherein the insulation sleeve has an emissivity in a range between 0.005 and 0.03.

3. The CEC of claim 2, wherein the insulation sleeve has a thermal conductivity rating in a range of 0.28-0.35 W/m·K (Watts per meter Kelvin), has an electrical dielectric strength in a range of 500-800 volts/mil, is non-magnetic, or a combination thereof.

4. The CEC of claim 1, wherein the at least one CCM spacer comprises low outgassing, extreme low temperature Liquid Silicone Rubber (LSR), and provides electrical separation and structural support for the each CCM.

5. The CEC of claim 1, further comprising a plenum defined by a plurality of plenum pins surrounding the CCM spacers and a bottom plenum cap, wherein the plenum, a channel of the CCM core, and the bottom plenum cap together define a flow path for receiving a cooling fluid to be dispersed across the CCM.

6. The CEC of claim 1, wherein each CCM comprises a first HTS double-pancake coil having a first spacer between each pancake layer, a second HTS double-pancake coil having a second spacer between each pancake layer, a third CCM Spacer disposed between the first HTS double-pancake coil and the second HTS double-pancake coil, a fourth spacer disposed above the first HTS double-pancake coil, and a fifth spacer disposed below the second double-pancake HTS coil.

7. The CEC of claim 1, wherein the at least two HTS double-pancake coils have a uniform length and a uniform coil tension.

8. The CEC of claim 1, wherein the at least two HTS double-pancake coils comprise or are compatible with HTS tape.

9. The CEC of claim 5, wherein the cold-can nipple top endcap has a plurality of openings, the plurality of openings comprising a gas inlet and a gas outlet.

10. The CEC of claim 9, further comprising a fluid flow path formed by the gas inlet of the top endcap, the internal cavity of the CCM core, one or more plenums, and the gas outlet of the top endcap.

11. The CEC of claim 10, wherein the fluid flow path facilitates flow of a cryogenic cooling fluid through the channel internal cavity of the CCM core to be redirected by the bottom plenum cap through the CCM spacers and contained by a middle plenum when traveling between CCMs.

12. The CEC of claim 11, wherein the plurality of openings in the cold-can nipple top endcap includes through-holes through which end portions of the HTS coils of the CEC modules pass, thereby facilitating connection to a high temperature superconducting (HTS) cable terminator.

13. The CEC of claim 1, wherein the CCM core and each CCM spacer comprises silicone and one or more embedded stiffeners.

14. The CEC of claim 1, wherein the CEC is enclosed in a vacuum vessel.

15. The CEC of claim 1, wherein at least one of the top endcap or the bottom endcap includes a plurality of electrical attachment ports and electrical connectors that pass therethrough for facilitating electrical connection of the CCA to an external system.

16. The CEC of claim 15, wherein each CCA comprises at least four CCMs stacked axially to form a stacked set.

17. The CEC of claim 16, comprising a plurality of CCAs.

18. The CEC of claim 16, wherein each magnetic field produced by each CCA in the stacked set is inductively coupled to another magnetic field produced by another CCA, thereby permitting the coupled magnetic fields of the stacked set to behave as a single additive magnetic field.

19. The CEC of claim 17, wherein the plurality of CCAs are arranged laterally in a symmetrical configuration.

20. The CEC of claim 11, wherein the cryogenic cooling fluid comprises helium gas in a temperature range of 30-90 K.
